(19) United States
(12) Patent Application Publication
(10) Pub. No.: US 2017/0050286 A1
(43) Pub. Date: Feb. 23, 2017

(54) AUTOMATIC MULTISTAGE GRINDING SYSTEM

(71) Applicant: EMAG Holding GmbH, Salach (DE)

(72) Inventor: Guido HEGENER, Remseck (DE)

(21) Appl. No.: 15/229,212

(22) Filed: Aug. 5, 2016

(30) Foreign Application Priority Data
Aug. 18, 2015 (DE) 102015010942.1

(51) Int. Cl. B24B 5/42; B24B 27/00; B24B 5/35

(52) U.S. Cl. CPC B24B 5/42; B24B 5/355; B24B 27/0023; B24B 27/0076

(57) ABSTRACT

Workpieces are machined in an apparatus having a central grinding station, first and second finishing stations and first and second spindles movable. First one of the workpieces is ground in a coarse-grinding station with the first spindle while rotating and finishing another of the workpieces with the second spindle in the second finishing station and then, while continuing to rotate and coarse grind the one workpiece in the coarse-grinding station, switching the other finished workpiece for an unmachined workpiece with the second spindle. Then the unmachined workpiece is ground in the coarse-grinding station with the second spindle while rotating and finishing the coarse-ground workpiece with the first spindle in the first finishing station and then, while continuing to rotate and coarse grind the unmachined workpiece in the coarse-grinding station, switching the finished workpiece for an unmachined workpiece with the first spindle.

### FIELD OF THE INVENTION

The present invention relates to a multistage grinding system. More particularly this invention concerns such a system that automatically pregrinds, coarse grinds, and finish grinds a workpiece.

### BACKGROUND OF THE INVENTION

German patent document 198 46 944 describes a system for grinding camshafts with several work stations with integrated sensors. The machine frame has a milling and grinding support. As for instance cams on the workpiece are ground, and corrections are calculated.

The subsequent finish machining is done on a separate apparatus such as described in French patent document 2,655,900, principally to impart a very exact contour to the cams. This finish grinder has a fine-grit belt carried on wheels on pivotal arms that allow the belt to be pressed against the workpiece surface to be finished.

### OBJECTS OF THE INVENTION

It is therefore an object of the present invention to provide an improved automatic multistage grinding system.

Another object is the provision of such an improved automatic multistage grinding system that overcomes the above-given disadvantages, in particular that does a complete pregrinding, coarse grinding, and finishing all in a simple manner and a reduced footprint.

### SUMMARY OF THE INVENTION

Workpieces are machined in an apparatus having a central grinding station, first and second finishing stations flanking the central grinding station, and first and second spindles movable between the respective finishing stations and the central grinding station. The apparatus executes the steps of:

a) rotating and coarse grinding one of the workpieces in the coarse-grinding station with the first spindle while rotating and finishing another of the workpieces with the second spindle in the second finishing station and then, while continuing to rotate and coarse grind the one workpiece in the coarse-grinding station, switching the other finished workpiece for an unmachined workpiece with the second spindle,

b) thereafter rotating coarse grinding the unmachined workpiece in the coarse-grinding station with the second spindle in the coarse-grinding station while rotating and finishing the coarse-ground workpiece with the first spindle in the first finishing station and then, while continuing to rotate and coarse grind the unmachined workpiece in the coarse-grinding station, switching the finished workpiece for an unmachined workpiece with the first spindle, and

c) repeating steps a) and b) with further workpieces.

Thus to central coarse grinder(s) is/are in operation nearly continuously, and the two spindles are continuously either holding a workpiece in one of the stations or exchanging a finished workpiece for an unmachined workpiece. This means that most of the apparatus is working nearly full-time for extremely high output and efficient use of equipment.

According to the invention the workpieces are rotated by the spindles in the stations about fixed vertical axes and have surfaces not centered on the axes about which they are rotated. The central grinding station has grinders movable radially of the respective axis.

The central grinding stations includes a pregrinder and a coarse grinder. In addition during finishing the workpieces are moved axially of the axis of the respective finishing station.

The machining apparatus has according to the invention a central grinder having a first grinding disk centered on and rotatable about a vertical first coarse-grinding axis, first and second finishers flanking the coarse-grinding axis and having grinding tools, and respective first and second spindles adapted to hold respective workpieces, rotate the workpieces about vertical axis, and movable horizontally between the respective first and second finishers and the central grinder and vertically to pick up and drop off the workpieces.

A tailstock is alignable with a rotation axis of the spindles in the coarse-grinding station.

In addition the central grinder has a second grinding disk centered on and rotatable about a vertical second coarse-grinding axis.

Furthermore the grinding disk is movable vertically of the respective coarse-grinding axis.

the grinding tool of each of the finishers can be a fine-grit finishing disk or a fine-grit finishing belt.

### BRIEF DESCRIPTION OF THE DRAWING

The above and other objects, features, and advantages will become more readily apparent from the following description, reference being made to the accompanying drawing in which:

FIG. 1 is a front view of the apparatus according to the invention with grinding-disk finishers; and

FIG. 2 is a top view of a portion of the apparatus of this invention using belt-type finishers.

### SPECIFIC DESCRIPTION OF THE INVENTION

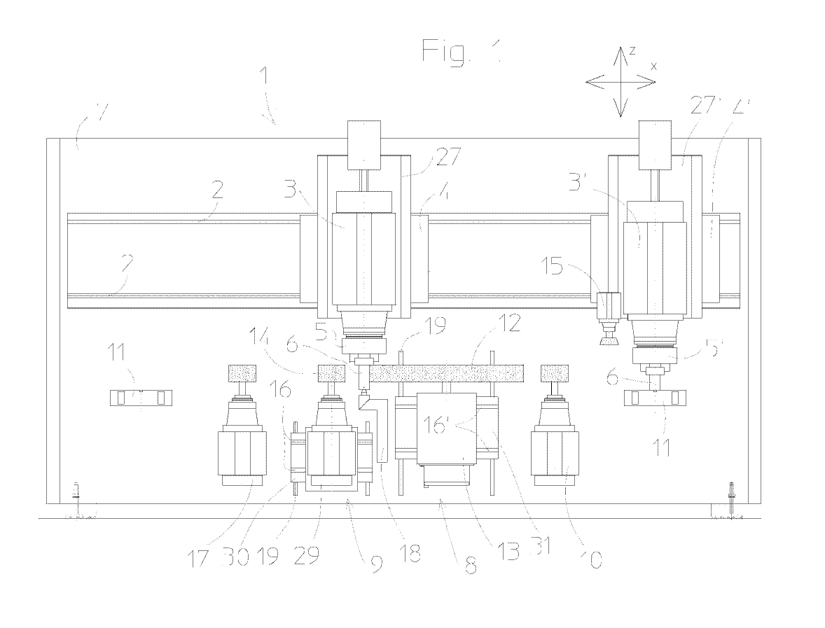

As seen in FIG. 1 the apparatus according to the invention has a frame 1 with a vertical and planar front wall 7 carrying horizontal guide rails 2 on which can move horizontal first and second slides 4 and 4′ each provided with a respective vertically displaceable slide 27 and 27′ carrying a respective first and second spindle drive 3 and 3′ defining a respective vertical rotation axis for a workpiece 6 held in a respective chuck 5 and 5′.

Below the workpiece spindles 3 and 3′ are two grinders 8 and 9 with coarse-grinding disks 12 and 14 and two finishers 10 and 17 with fine-grit disks, all rotatable about vertical axes. The disk 12 of the grinder 8 is of greater diameter than its drive motor 13 while the disk 14 of the grinder 9 is smaller than its motor 29. These grinders 8 and 9 are carried on slides 30 and 31 vertically displaceable on the wall 7 on rails 19 and are in turn horizontally displaceable on the slides 30 and 31 on respective horizontal guide rails 16 and 16′. The grinders 8 and 9 can operate independently or can both be brought diametrally into engagement with a workpiece 6 to simultaneously grind opposite sides and the radial forces the grinder 8 and 9 exert on the workpiece 6 cancel each other out and ensure accurate coarse grinding while simultaneously grinding twice as fast.

This vertical displaceability of the grinding tools 12 and 14 allows the workpieces 6 to be positioned between them. In addition the vertically displaceability of the chucks 5 and 5′ similarly allows workpieces 6 to be picked up and dropped off on conveyors 11 and 11′ that extend perpendicular to a plane defined by horizontal and vertical directions x and y bring unfinished workpieces 6 into each side of the apparatus and take finished workpieces 6 away.

A dresser 15 is provided on one of the slides (here slide 27′) for finishing the grinding disks 12 and 14.

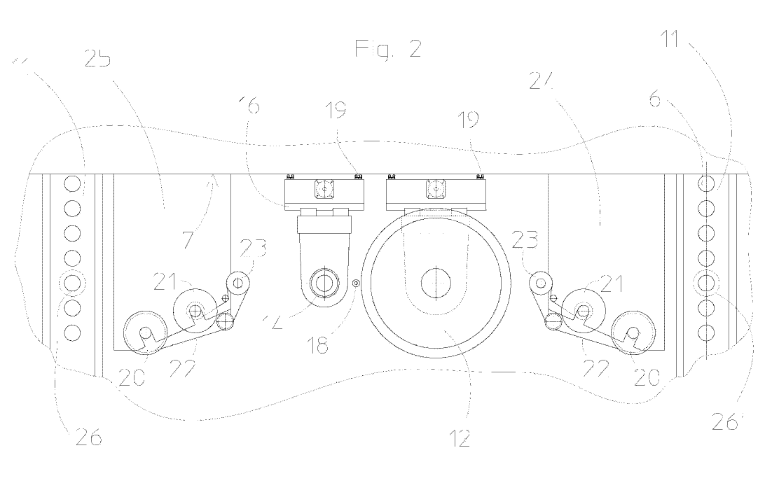

FIG. 2 shows an alternate system where, instead of finishers 10 and 17 with fine-grit grinding disks, there are finishers 24 and 25, each having a roll 20 of grinding strip 22 that is passed around a roller 23 and wound up on a takeup roller 21. The rollers 23 are pressed against the workpieces 6 to finish them after coarse machining between the grinders 8 and 9. During finishing the workpieces 6 are rotated by the spindles 3 and 2′ and even reciprocated vertically along their rotation axes while engaging the fine-grit strip 22.

The system executes the following steps:
Step 1—The first spindle 3 picks a workpiece 6 up out of the station 26 on the conveyor and coarse grinds it with the grinders 8 and/or 9 while the second spindle 3′ finishes its workpiece 6 in second finisher 10 or 24.
Step 2—While the first spindle 3 still coarse grinds with the grinder 8 and/or 9 its workpiece 6, the second spindle 3′ drops off the finished workpiece 6 in a station 26′ in the conveyor 11′ and picks up an unmachined workpiece 6 from the conveyor 11′. (See FIG. 1)
Step 3—The first spindle 3 then moves with the coarse-ground workpiece 6 to the first finisher 17 or 25 while the second spindle 3′ moves with the unmachined workpiece 6 it just picked up to the coarse grinder 8 and/or 9.
Step 4—The first spindle 3 finishes the coarse-ground workpiece 6 in the first finisher 17 or 25 while the second spindle 3′ coarse grinds with the grinder 8 and/or 9 the unmachined workpiece 6.
Step 5—The first spindle 3 drops off the finished workpiece 6 and picks up an unmachined workpiece 6 from the station 26 in its conveyor 11 while the second spindle 3′ still coarse grinds with the grinder 8 and/or 9 its workpiece 6.
Step 6—The first spindle 3 moves with new unmachined workpiece 6 to coarse grinder 8 and/or 9 and the second spindle 3′ moves with the coarse-ground workpiece 6 to the second finisher 10 or 24.

Steps 1-6 repeated.

Thus the coarse grinder(s) 8 and/or 9 are in nearly continuous use, while the two spindles 3 and 3′ move back and forth between their respective conveyors 11 and 11′ and finishers 17, 25 or 10, 24. Each of the finishers 10, 17 or 24, 25 is working only part of the time. Both of the spindles 3 and 3′ are continuously active either holding a workpiece 6 for the grinders 8 and 9 or for the finishers 10, 17, 24, or 25 or picking up or dropping of workpieces from the conveyors 11 and 11′

I claim:

1. A method of machining workpieces in an apparatus having:
a central grinding station,
first and second finishing stations flanking the central grinding station, and
first and second spindles movable between the respective finishing stations and the central grinding station; the method comprising the steps of:
a) rotating and coarse grinding one of the workpieces in the coarse-grinding station with the first spindle while rotating and finishing another of the workpieces with the second spindle in the second finishing station and then, while continuing to rotate and coarse grind the one workpiece in the coarse-grinding station, switching the other finished workpiece for an unmachined workpiece with the second spindle;
b) thereafter coarse grinding the unmachined workpiece in the coarse-grinding station with the second spindle while rotating and finishing the coarse-ground workpiece with the first spindle in the first finishing station and then, while continuing to rotate and coarse grind the unmachined workpiece in the coarse-grinding station, switching the finished workpiece for an unmachined workpiece with the first spindle; and
c) repeating steps a) and b) with further workpieces.

2. The machining method defined in claim 1, wherein the workpieces are rotated by the spindles in the stations about fixed vertical axes and have surfaces not centered on the axes about which they are rotated, the central grinding station having grinders movable radially of the respective axis.

3. The machining method defined in claim 2, wherein the central grinding stations includes a pregrinder and a coarse grinder.

4. The machining method defined in claim 1, wherein during finishing the workpieces are moved axially of the axis of the respective finishing station.

5. A machining apparatus comprising:
a central grinder having a first grinding disk centered on and rotatable about a vertical first coarse-grinding axis;
first and second finishers flanking the coarse-grinding axis and having grinding tools; and
respective first and second spindles adapted to hold respective workpieces, rotate the workpieces about vertical axis, and movable horizontally between the respective first and second finishers and the central grinder and vertically to pick up and drop off the workpieces.

6. The apparatus defined in claim 5, further comprising a tailstock alignable with a rotation axis of the spindles in the coarse-grinding station.

7. The apparatus defined in claim 5, wherein the central grinder has a second grinding disk centered on and rotatable about a vertical second coarse-grinding axis.

8. The apparatus defined in claim 5 wherein the grinding disk is movable vertically of the respective coarse-grinding axis.

9. The apparatus defined in claim 5, wherein the grinding tool of each of the finishers is a fine-grit finishing disk.

10. The apparatus defined in claim 5, wherein the grinding tool of each of the finishers is a fine-grit finishing belt.
